(19) United States
(12) Patent Application Publication
(10) Pub. No.: US 2023/0322209 A1
(43) Pub. Date: Oct. 12, 2023

(54) PARKING MANAGEMENT DEVICE, VEHICLE, AND PARKING MANAGEMENT METHOD

(71) Applicant: TOYOTA JIDOSHA KABUSHIKI KAISHA, Toyota-shi (JP)

(72) Inventors: Daisaku HONDA, Nagoya-shi (JP); Hiroya MATSUBAYASHI, Nisshin-shi (JP); Ryota TOMIZAWA, Mishima-shi (JP); Satoshi TANABE, Susono-shi (JP); Nobutsugu MARUIWA, Mishima-shi (JP); Yasuhiro KOBATAKE, Nagoya-shi (JP); Hiroki AWANO, Susono-shi (JP)

(73) Assignee: TOYOTA JIDOSHA KABUSHIKI KAISHA, Toyota-shi (JP)

(21) Appl. No.: 18/106,132

(22) Filed: Feb. 6, 2023

(30) Foreign Application Priority Data
Apr. 11, 2022 (JP) 2022-065213

(51) Int. Cl. B60W 30/06; G05D 1/00; B60W 60/00

(52) U.S. Cl. CPC B60W 30/06; G05D 1/0022; B60W 2552/00; B60W 2556/45; B60W 60/001

(57) ABSTRACT

A parking management device includes: a receiving unit that receives a vehicle movement request transmitted from a user so as to move a parked vehicle; a specifying unit that specifies the parked vehicle from among the vehicles in a parking lot based on the vehicle movement request; and a transmitting unit that transmits a vehicle movement mode command to the parked vehicle, the vehicle movement mode command being a command for causing a driving mode of the parked vehicle specified by the specifying unit to transition to a vehicle movement mode in which the parked vehicle is caused to execute a vehicle movement operation for moving the parked vehicle.

### CROSS-REFERENCE TO RELATED APPLICATION

This application claims priority to Japanese Patent Application No. 2022-065213 filed on Apr. 11, 2022, incorporated herein by reference in its entirety.

### BACKGROUND

### 1. Technical Field

The present disclosure relates to a parking management device, a vehicle, a parking management method.

### 2. Description of Related Art

A technique for remotely controlling a parked vehicle is known (for example, Japanese Unexamined Patent Application Publication No. 2008-33438 (JP 2008-33438 A)).

### SUMMARY

Vehicles parked in the parking lot can interfere with the user of the parking lot. As described above, there is a demand to move the vehicle that interferes with the user.

A first aspect of the present disclosure is a parking management device that manages a vehicle in a parking lot, and includes: a receiving unit that receives a vehicle movement request transmitted from a user of the parking lot so as to move the parked vehicle; a specifying unit that specifies the parked vehicle from among the vehicles in a parking lot based on the vehicle movement request; and a transmitting unit that transmits a vehicle movement mode command to the parked vehicle, the vehicle movement mode command being a command for causing a driving mode of the parked vehicle specified by the specifying unit to transition to a vehicle movement mode in which the parked vehicle is caused to execute a vehicle movement operation for moving the parked vehicle.

A second aspect of the present disclosure is the parking management device according to the first aspect. In the parking management device, the receiving unit receives, as the vehicle movement request, a vehicle specification request including information that specifies the parked vehicle, and the specifying unit specifies the parked vehicle based on the vehicle specification request.

A third aspect of the present disclosure is the parking management device according to the second aspect. In the parking management device, the information that specifies the parked vehicle includes an automobile registration number of the parked vehicle or an identification code uniquely assigned to the parked vehicle.

A fourth aspect of the present disclosure is the parking management device according to any one of the first to third aspects. In the parking management device, the transmitting unit transmits a self-propulsion command to the parked vehicle that has transitioned to the vehicle movement mode, and the parked vehicle is self-propelled, as the vehicle movement operation, in a direction that is predetermined in accordance with the self-propulsion command received after the parked vehicle has transitioned to the vehicle movement mode.

A fifth aspect of the present disclosure is the parking management device according to the fourth aspect. In the parking management device, the receiving unit further receives imaging data of the vehicle in the parking lot from an infrastructure sensor provided in the parking lot so as to capture an image of the vehicle, the parking management device further includes a self-propelled route determination unit that determines the direction in which the parked vehicle is self-propelled in the vehicle movement operation based on the imaging data, and the transmitting unit generates the self-propulsion command for causing the parked vehicle to be self-propelled in the direction determined by the self-propelled route determination unit.

A sixth aspect of the present disclosure is the parking management device according to the fourth aspect. In the parking management device, the receiving unit receives, as the vehicle movement request, a self-propulsion request for causing the parked vehicle to be self-propelled, and the transmitting unit generates the self-propulsion command in accordance with the self-propulsion request.

A seventh aspect of the present disclosure is the parking management device according to the sixth aspect. In the parking management device, the self-propulsion request includes information that specifies the direction, and the transmitting unit generates the self-propulsion command for causing the vehicle to be self-propelled in the direction specified in the self-propulsion request.

An eighth aspect of the present disclosure is the parking management device according to any one of the first to third aspects. In the parking management device, the transmitting unit transmits a communication establishment command to the parked vehicle or a mobile device of the user, the communication establishment command being a command for establishing communication between the parked vehicle that has transitioned to the vehicle movement mode and the mobile device, and after the communication between the parked vehicle and the mobile device is established, the parked vehicle is self-propelled, as the vehicle movement operation, in a predetermined direction in accordance with a self-propulsion command transmitted from the mobile device.

A ninth aspect of the present disclosure is a vehicle that transitions to the vehicle movement mode in accordance with the vehicle movement mode command transmitted from the transmitting unit of the parking management device according to any one of the first to the eighth aspects and executes the vehicle movement operation.

A tenth aspect of the present disclosure is the vehicle according to the ninth aspect. When the vehicle transitions to the vehicle movement mode, the vehicle cancels actuation of a braking mechanism as the vehicle movement operation.

An eleventh aspect of the present disclosure is the vehicle according to the ninth or the tenth aspect. The vehicle includes a sensor that detects a contact operation with respect to the vehicle by the user, and is self-propelled, as the vehicle movement operation, in a predetermined direction in accordance with the contact operation detected by the sensor after the vehicle transitions to the vehicle movement mode.

A twelfth aspect of the present disclosure is a parking management method of managing a vehicle in a parking lot. In the method, a processor receives a vehicle movement request transmitted from a user of the parking lot so as to move the parked vehicle, specifies the parked vehicle from among the vehicles in the parking lot based on the vehicle movement request, and transmits a vehicle movement mode command to the parked vehicle, the vehicle movement mode command being a command for causing a driving mode of the parked vehicle specified to transition to a vehicle movement mode in which the parked vehicle is caused to execute a vehicle movement operation for moving the parked vehicle.

According to the present disclosure, when the parked vehicle in the parking lot is interfering with the user, the user transmits the vehicle movement request to the parking management device to cause the vehicle to execute the vehicle movement operation, whereby it is possible to move the vehicle. Therefore, it is possible to enhance convenience of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a parking management system according to an embodiment, a parking lot, and vehicles in the parking lot;

FIG. 2 is a block diagram showing the parking management system shown in FIG. 1;

FIG. 3 is a flowchart showing a parking management method according to an embodiment;

FIG. 4 is a block diagram of a vehicle according to an embodiment;

FIG. 5 is a block diagram showing another function of the parking management system shown in FIG. 2;

FIG. 6 is a flowchart showing a parking management method according to another embodiment;

FIG. 7 is a flowchart showing a parking management method according to further another embodiment;

FIG. 8 shows an example of a vehicle operation screen;

FIG. 9 is a flowchart showing a parking management method according to further another embodiment;

FIG. 10 is a block diagram of a vehicle according to another embodiment; and

FIG. 11 is a flowchart showing a parking management method according to further another embodiment.

### DETAILED DESCRIPTION OF EMBODIMENTS

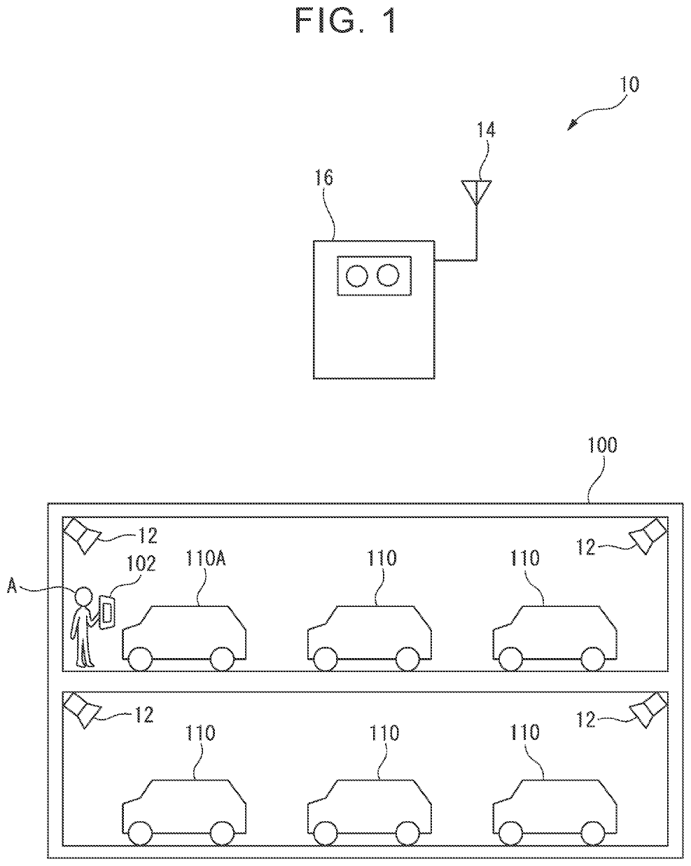

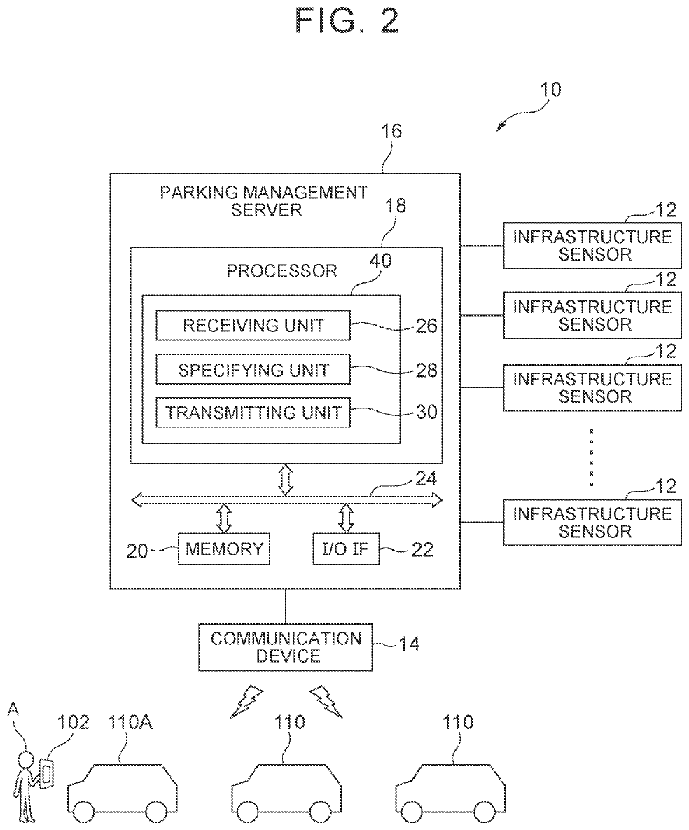

Hereinafter, embodiments of the present disclosure will be described in detail based on the drawings. In the various embodiments described below, the same reference signs are given to the same elements, and redundant description thereof will be omitted. First, a parking management system 10 according to an embodiment will be described with reference to FIGS. 1 and 2. The parking management system 10 is a system for managing vehicles 110 parked in a parking lot 100.

The parking management system 10 includes a plurality of infrastructure sensors 12, a communication device 14, and a parking management server 16. Each of the infrastructure sensors 12 includes a camera or laser scanner or the like and is provided in the parking lot 100 to capture an image of the vehicles 110 in the parking lot 100. The infrastructure sensors 12 are distributed and installed in multiple locations in the parking lot 100 such that an image of the vehicle 110 parked in each parking frame defined in the parking lot 100 can be captured. Each infrastructure sensor 12 captures an image of the vehicle 110 in the parking lot 100, and supplies an imaging data IM of the vehicle 110 to the parking management server 16.

The communication device 14 is capable of data communication with an external communication device including the vehicles 110 in the parking lot 100. Specifically, the communication device 14 wirelessly transmits and receives data to and from the external communication device such as the vehicles 110 in the parking lot 100 using, for example, a mobile communication network system such as the fourth generation (4G) or the fifth generation (5G). Note that, a plurality of the communication devices 14 may be provided in the parking lot 100 such that communication with the vehicle 110 parked in each parking frame in the parking lot 100 is allowed. Further, the communication device 14 may also communicate with an external communication device in any communication protocol.

The parking management server 16 controls operations of the infrastructure sensors 12 and the communication device 14. Specifically, as shown in FIG. 2, the parking management server 16 is a computer provided with a processor 18, a memory 20, and an input/output (I/O) interface 22. The processor 18 includes a central processing unit (CPU) or a graphics processing unit (GPU), and is communicatively connected to the memory 20 and the I/O interface 22 via a bus 24. The processor 18 performs arithmetic processing for realizing a vehicle management function to be described later.

The memory 20 includes a random access memory (RAM), a read-only memory (ROM), or the like, and temporarily or permanently stores various types of data used in the arithmetic processing executed by the processor 18, and various types of data generated in the middle of the arithmetic processing. The I/O interface 22 includes, for example, an Ethernet (registered trademark) port, a universal serial bus (USB) port, or a high-definition multimedia interface (HDMI; registered trademark) terminal, and performs wired or wireless communication of data with an external device such as the infrastructure sensors 12 and the communication device 14.

Here, the vehicles 110 parked in the parking lot 100 may interfere with walking or baggage transportation of a user A of the parking lot 100. As described above, there is a demand to move each vehicle 110 that interferes with the user. Therefore, in the present embodiment, the processor 18 manages the vehicles 110 in the parking lot 100 so as to move the parked vehicle 110 in response to a request from the user A.

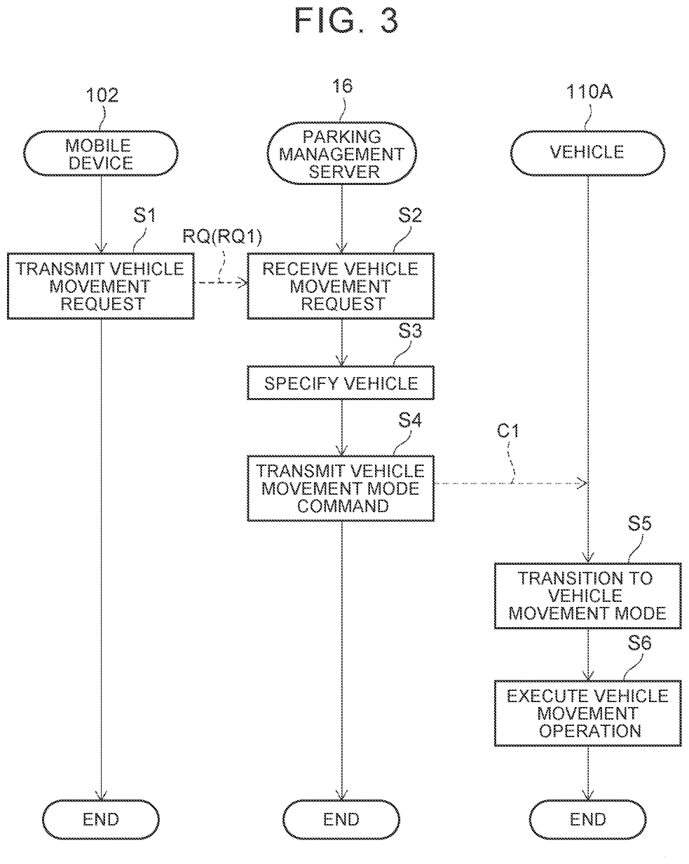

Hereinafter, with reference to FIG. 3, a parking management method according to the embodiment will be described. Here, in the present embodiment, an owner B of each vehicle 110 to be parked in the parking lot 100 makes a user registration of the parking lot 100 in advance to use the parking lot 100. For example, the owner B operates a human machine interface (HMI) of the vehicle 110, accesses the parking management server 16 through an on-board communication device of the vehicle 110, downloads an application a for making the user registration of the parking lot 100 from the parking management server 16, and installs the application a onto an electronic control unit (ECU) of the vehicle 110.

Then, the owner B starts the application a by operating the HMI, inputs personal information PI (name, address, telephone number, etc.) of the owner B and specification information SI for specifying the vehicle 110 through a user registration screen SC1 displayed on the display of the HMI of the vehicle 110, and uploads the input data to the parking management server 16 through the on-board communication device of the vehicle 110.

The specification information SI includes, for example, an automobile registration number SI1 of the vehicle 110 or an identification code SI2 uniquely assigned to each vehicle 110. The automobile registration number SI1 can be printed on a license plate attached to each of the front and the rear of the vehicle 110. On the other hand, the identification code SI2 includes a bar code or QR code (registered trademark), and may be, for example, affixed to the exterior (a windshield, a rear glass, a side window, a body, etc.) of the vehicle 110 as a label seal, or may be directly printed on the exterior.

The processor 18 of the parking management server 16 acquires the personal information PI and the specification information SI received from the on-board communication device of the vehicle 110 through the communication device 14, and acquires a communication address AR assigned to the on-board communication device of the vehicle 110 (e.g., IP address). Then, the processor 18 creates a database DB in which the acquired personal information PI, the specification information SI, and the address AR are stored in association with each other, and stores the database DB in the memory 20 in advance. Thus, prior to use of the parking lot 100, the specification information SI and the addresses AR of the vehicles 110 are stored in the database DB.

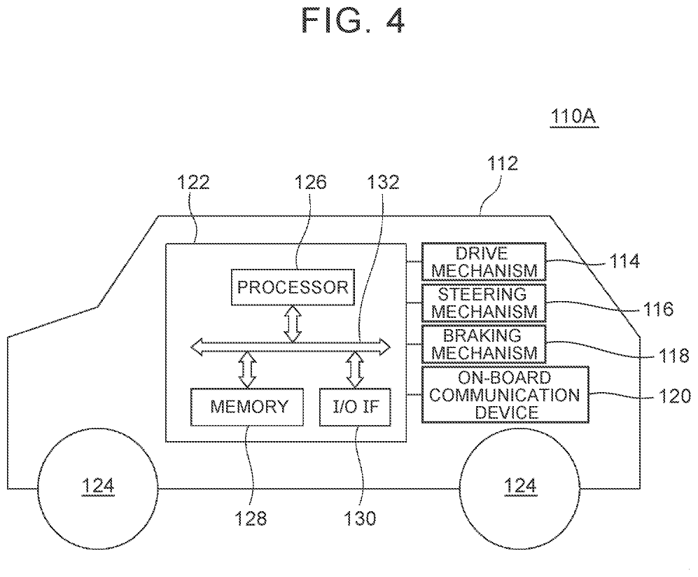

Here, among the vehicles 110 in the parking lot 100, a vehicle 110A that is parked (FIGS. 1 and 2) is assumed to interfere with the user A. Hereinafter, with reference to FIG. 4, a configuration of the vehicle 110A will be described with reference to FIG. 4. The vehicle 110A is, for example, a four-wheel automobile, and includes a vehicle body 112, a drive mechanism 114, a steering mechanism 116, a braking mechanism 118, an on-board communication device 120, an electronic control unit (ECU) 122, and the like. The vehicle body 112 includes an exterior 112A including the windshield, the rear glass, the side windows, the body, and the like and an interior 112B including seats, an instrument cluster, a room mirror, and the like.

The drive mechanism 114 includes an engine or an electric motor or the like, and generates a driving force for driving the vehicle 110A by rotationally driving wheels 124 that are rotatably provided on the vehicle body 112. The steering mechanism 116 includes a power steering device and the like, and automatically changes the traveling direction of the vehicle 110A. The braking mechanism 118 includes an electric brake device or the like, and automatically brakes the vehicle 110A by applying a braking force to the wheels 124.

The ECU 122 controls the operation of the vehicle 110A. Specifically, the ECU 122 is a computer provided with a processor 126, a memory 128, and an I/O interface 130. The processor 126 includes a CPU or a GPU and is communicatively connected to the memory 128 and the I/O interface 130 via a bus 132.

The memory 128 includes a RAM, a ROM, or the like, and temporarily or permanently stores various types of data used in the arithmetic processing executed by the processor 126, and various types of data generated in the middle of the arithmetic processing. The I/O interface 130 includes, for example, a controller area network (CAN) port, an Ethernet (registered trademark) port, a USB port, an optical fiber connector, or an HDMI (registered trademark) terminal, and performs wired or wireless communication of data with on-board components such as the drive mechanism 114, the steering mechanism 116, the braking mechanism 118, and the on-board communication device 120.

The on-board communication device 120 can communicate with the external communication device such as the communication device 14 of the parking management system 10. The on-board communication device 120 includes, for example, a global positioning system (GPS) receiver 120A, an inter-vehicle communication device 120B, and a data communication module (DCM) 120C. The GPS receiver 120A receives GPS signals from GPS satellites. The inter-vehicle communication device 120B can transmit and receive data to and from the on-board communication device of another vehicle.

The DCM 120C can transmit and receive data to and from the external communication device of the vehicle 110A (e.g., the communication device 14 described above, a mobile device 102 to be described later, a communication device provided in the management server of an automobile company, a communication base station, etc.) using a mobile communication network system such as 4G or 5G. Note that, the vehicle 110 other than the vehicle 110A has the configuration same as or similar to that of the vehicle 110A.

With reference to FIGS. 1 to 3 again, the user A operates the owned mobile device 102 (a smartphone or a tablet terminal device, etc.), and transmits a vehicle movement request RQ for moving the interfering vehicle 110A to the parking management server 16 (step S1 in FIG. 3).

Here, before the vehicle movement request RQ is transmitted, the user A accesses the parking management server 16 by operating the mobile device 102, downloads the application a described above from the parking management server 16, and installs the application a in the mobile device 102 in advance. The user A operates the mobile device 102 to start the application a, inputs personal information PI_{A} of the user A through the user registration screen SC1 displayed on the display of the mobile device 102, and uploads the personal information PI_{A} from the mobile device 102 to the parking management server 16.

The processor 18 of the parking management server 16 acquires the personal information PI_{A} of the user A through the communication device 14, and acquires the communication address AR_{A} assigned to the mobile device 102 (e.g., IP address). The processor 18 stores the personal information PI_{A} and the address AR_{A} in the database DB described above in association with each other. After such user registration is made, the user A can transmit the vehicle movement request RQ through a movement request input screen SC2 displayed when the application a is started on the mobile device 102.

In the present embodiment, in step S1, the user A transmits a vehicle specification request RQ1 including specification information SI_{110A} (an automobile registration number SI1_{110A} of the vehicle 110A, or an identification code SI2_{110A} uniquely assigned to the vehicle 110A) that specifies the vehicle 110A to the parking management server 16 as the vehicle movement request RQ.

As an example, the user A operates the mobile device 102 in accordance with guidance information displayed on the movement request input screen SC2 of the application a, and captures an image of the automobile registration number SI1_{110A} of the vehicle 110A by a camera provided in the mobile device 102. The mobile device 102 reads the automobile registration number SI1_{110A} from the image captured by the camera, and transmits the vehicle specification request RQ1 accompanied by the information of the automobile registration number SI1_{110A} to the parking management server 16 as the vehicle movement request RQ in response to the operation of the user A.

As another example, the user A operates the mobile device 102 to capture an image of the identification code SI2_{110A} assigned to the vehicle 110A by the camera provided in the mobile device 102, and reads the identification code SI2_{110A}. Then, the mobile device 102 transmits the vehicle specification request RQ1 accompanied by the read identification code SI2_{110A} to the parking management server 16 in response to the operation of the user A. Thus, the mobile device 102 transmits the vehicle specification request RQ1 including the specification information SI1_{110A} (the automobile registration number SI1_{110A}, or the identification code SI2_{110A}) to the parking management server 16 as the vehicle movement request RQ.

The processor 18 of the parking management server 16 receives the vehicle movement request RQ transmitted from the user A (step S2). Specifically, the communication device 14 receives the vehicle specification request RQ1 as the vehicle movement request RQ from the mobile device 102 of the user A. The processor 18 of the parking management server 16 receives the vehicle specification request RQ1 through the communication device 14. As described above, the processor 18 functions as a receiving unit 26 (FIG. 2) that receives the vehicle movement request RQ (specifically, the vehicle specification request RQ1).

Next, the processor 18 specifies the vehicle 110A from among the vehicles 110 in the parking lot 100 based on the vehicle movement request RQ received by the receiving unit 26 (step S3). Specifically, the processor 18 specifies the vehicle 110A stored in the database DB by comparing the specification information SI_{110A} (i.e., the automobile registration number SI1_{110A}, or the identification code SI2_{110A}) included in the vehicle specification request RQ1 received in step S2 above with the specification information SI stored in the database DB described above.

Then, the processor 18 acquires the address AR_{110A} assigned to the on-board communication device 120 of the specified vehicle 110A from the database DB. As described above, in the present embodiment, the processor 18 functions as a specifying unit 28 (FIG. 2) that specifies the vehicle 110A from among the vehicles 110 in the parking lot 100 based on the vehicle movement request RQ (specifically, the vehicle specification request RQ1).

Next, the processor 18 transmits a vehicle movement mode command C1 to the vehicle 110A identified in step S3 described above (step S4). The vehicle movement mode command C1 is a command for causing a driving mode DM of the vehicle 110A specified in step S3 to transition to a vehicle movement mode DM1. The vehicle movement mode DM1 is the driving mode DM for causing the vehicle 110A to execute a vehicle movement operation MO for moving the vehicle 110A from a current parking position P0.

The processor 18 causes the communication device 14 of the parking management system 10 to operate with reference to the address AR_{110A} assigned to the on-board communication device 120 of the vehicle 110A and acquired in step S3 described above, and transmits the vehicle movement mode command C1 to the on-board communication device 120 of the vehicle 110A. As described above, in the present embodiment, the processor 18 functions as a transmitting unit 30 (FIG. 2) that transmits the vehicle movement mode command C1 to the vehicle 110A.

The processor 126 of the vehicle 110A causes the driving mode DM of the vehicle 110A to transition to the vehicle movement mode DM1 in accordance with the vehicle movement mode command C1 received through the on-board communication device 120 (step S5). After the transition to the vehicle movement mode DM1, the processor 126 executes the vehicle movement operation MO for moving the vehicle 110A from the current parking position P0 (step S6).

As an example of the vehicle movement operation MO, the processor 126 cancels actuation of the braking mechanism 118 when the mode transitions to the vehicle movement mode DM1. Specifically, the processor 126 transmits a command to the electric braking device of the braking mechanism 118, and the electric braking device releases the braking force applied to the wheels 124 (i.e., releasing of the brake).

As described above, actuation of the braking mechanism 118 is canceled, and the vehicle 110A is placed in a movable state. As a result, the user A can move the vehicle 110A to a parking position P1 where the vehicle 110A does not interfere with the user A by, for example, pushing the vehicle 110A by hand. Another example of the vehicle movement operation MO will be described later.

As described above, in the present embodiment, the processor 18 functions as the receiving unit 26, the specifying unit 28, and the transmitting unit 30 so as to manage the vehicles 110 in the parking lot 100 such that the parked vehicle 110A is moved in accordance with the vehicle movement request RQ of the user A. Accordingly, the receiving unit 26, the specifying unit 28, and the transmitting unit 30 constitute a parking management device 40 for managing the vehicles 110 in the parking lot 100 (FIG. 2).

In the parking management device 40, the receiving unit 26 receives the vehicle movement request RQ transmitted from the user A so as to move the parked vehicle 110A (step S2), and the specifying unit 28 specifies the vehicle 110A from among the vehicles 110 in the parking lot 100 based on the vehicle movement request RQ (specifically, the vehicle specification request RQ1) (step S3).

Then, the transmitting unit 30 transmits, to the vehicle 110A, the vehicle movement mode command C1 for causing the driving mode DM of the vehicle 110A specified by the specifying unit 28 to transition to the vehicle movement mode DM1 in which the vehicle 110A is caused to execute the vehicle movement operation MO (e.g., brake release operation) for moving the vehicle 110A (step S4).

According to this configuration, when the vehicle 110A is interfering with the user A, the user A transmits the vehicle movement request RQ to the parking management device 40 to cause the vehicle 110A to execute the vehicle movement operation MO (e.g., releasing of the brake), whereby it is possible to move the vehicle 110A. Therefore, it is possible to enhance convenience of the user A.

Further, in the parking management device 40, the receiving unit 26 receives the vehicle specification request RQ1 including the specification information SI1_{110A} for specifying the vehicle 110A as the vehicle movement request RQ, and the specifying unit 28 specifies the vehicle 110A based on the vehicle specification request RQ1. More specifically, the specification information SI_{110A} includes the automobile registration number SI1_{110A} of the parked vehicle 110A, or the identification code SI2_{110A} uniquely assigned to the parked vehicle 110A.

According to this configuration, the specifying unit 28 can specify the vehicle 110A that is required to move by the user A with high accuracy and quickly. Note that, the vehicle movement request RQ may include any type of information that can specify the parked vehicle 110A (e.g., the number of the parking frame where the vehicle 110A is parked) other than the vehicle specification request RQ1 (i.e., the automobile registration number SI1_{110A}, the identification code SI2_{110A}).

In one example of step S1 described above, the user A may capture an image of the automobile registration number SI1_{110A} of the vehicle 110A by the camera of the mobile device 102, and may transmit the vehicle specification request RQ1 attached with imaging data IM′ of the automobile registration number SI1_{110A} to the parking management server 16 as the specification information SI1_{110A}. Then, in step S3, the processor 18 of the parking management server 16 may read the automobile registration number SI1_{110A} as the specification information SI_{110A} from the imaging data IM′ by performing image analysis of the imaging data IM′ attached to the vehicle specification request RQ1.

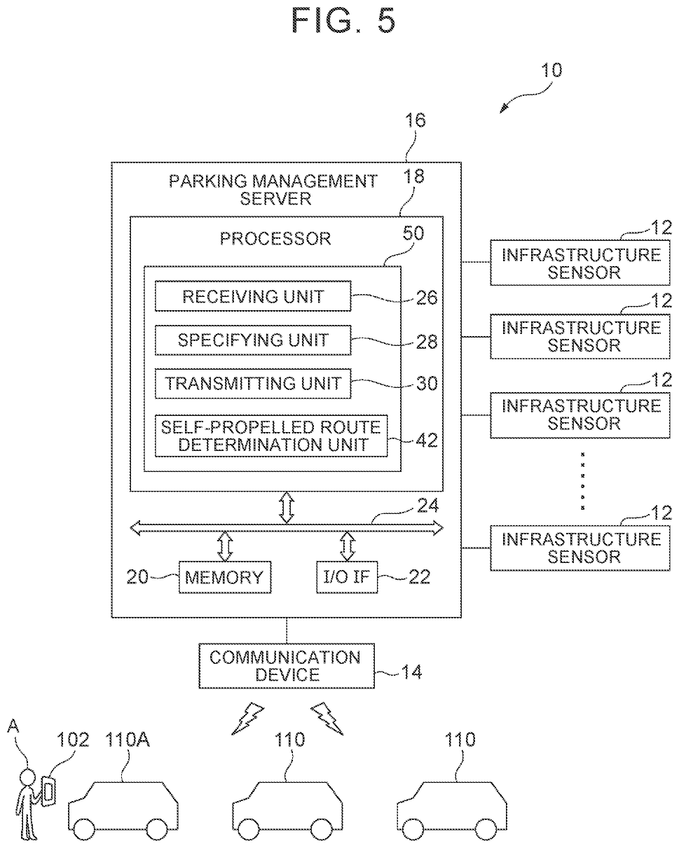

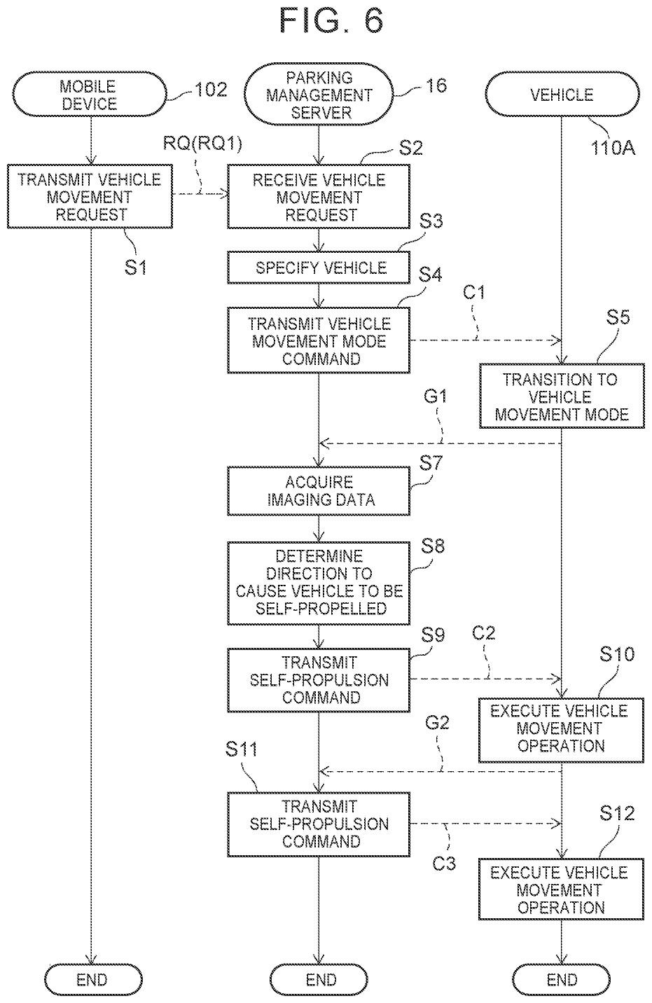

Hereinafter, with reference to FIGS. 5 and 6, a parking management method according to another embodiment will be described. The parking management system 10 shown in FIG. 5 executes the flow of the parking management method shown in FIG. 6. The same or similar process as or to the flow shown in FIG. 3 in the flow shown in FIG. 6 is denoted by the same step number, and redundant description will be omitted.

In the flow shown in FIG. 6, when the mode transitions to the vehicle movement mode DM1 in step S5, the processor 126 of the vehicle 110A enters a state where self-propulsion commands C2, C4, and C6 to be described later can be received, and transmits a mode transition signal G1 indicating that the mode has transitioned to the vehicle movement mode DM1 to the parking management server 16.

When the mode transition signal G1 is received from the vehicle 110A through the communication device 14, the processor 18 of the parking management server 16 operates at least one of the infrastructure sensors 12 to capture an image of the vehicle 110A. For example, the infrastructure sensor 12 continuously captures an image of each vehicle 110 (including the vehicle 110A) entering the parking lot 100, and the processor 18 collects the imaging data IM of the vehicle 110 captured by the infrastructure sensor 12.

Then, the processor 18 acquires the automobile registration number SI1 of the entered vehicle 110 based on the collected imaging data IM, and specifies which parking frame (or, the parking location in the parking lot 100) the vehicle 110 is parked. The processor 18 operates at least one infrastructure sensor 12 that captures the parking frame (or the parking location) where the vehicle 110A specified in step S3 described above is parked in the field of view, and functions as the receiving unit 26 to receive imaging data IM_{110A} obtained by capturing an image of the vehicle 110A from the at least one infrastructure sensor 12 (step S7).

Then, the processor 18 determines a self-propelled direction DR in which the vehicle 110A is self-propelled in the vehicle movement operation MO based on the acquired imaging data IM_{110A} (step S8). More specifically, the processor 18 recognizes the presence of an environmental object (e.g., another vehicle 110, the user A, constructions such as walls) around the vehicle 110A based on the imaging data IM_{110A}.

The processor 18 then determines the self-propelled direction DR such that the vehicle 110A does not contact the surrounding environmental object, thereby defining a self-propelled route RT defined by the self-propelled direction DR. Thus, in the present embodiment, the processor 18 functions as a self-propelled route determination unit 42 (FIG. 5) that determines, based on the imaging data IM_{110A}, the self-propelled direction DR (or the self-propelled route RT) in which the vehicle 110A is self-propelled in the vehicle movement operation MO.

Then, the processor 18 generates a self-propulsion command C2 for causing the vehicle 110A to be self-propelled based on the determined self-propelled direction DR (i.e., the self-propelled route RT). The self-propulsion command C2 is a command for causing the vehicle 110A to be self-propelled in the self-propelled direction DR along the self-propelled route RT as the vehicle movement operation MO, and includes, for example, control signals for automatically controlling the drive mechanism 114, the steering mechanism 116, and the braking mechanism 118 of the vehicle 110A.

Then, the processor 18 functions as the transmitting unit 30, and transmits the generated self-propulsion command C2 to the vehicle 110A that has transitioned to the vehicle movement mode DM1 by operating the communication device 14 (step S9). Specifically, the processor 18 refers to the address AR_{110A} of the vehicle 110A acquired in step S3 described above, and transmits the self-propulsion command C2 to the vehicle 110A through the communication device 14.

The processor 126 of the vehicle 110A receives the self-propulsion command C2 through the on-board communication device 120. Then, in accordance with the received self-propulsion command C2, after the processor 126 automatically controls the drive mechanism 114, the steering mechanism 116, and the braking mechanism 118 and cancels actuation of the braking mechanism 118 as the vehicle movement operation MO, the vehicle 110A is self-propelled in the self-propelled direction DR determined in step S8 (step S10). As a result, the vehicle 110A automatically moves along the self-propelled route RT from an original parking position P0 to a new parking position P1 without contacting the surrounding environmental object.

Note, the vehicle 110A may further include a sensor such as an external camera or radar (e.g., light detection and ranging (LiDAR)) for monitoring the surroundings of the vehicle 110A, and the processor 126 of the vehicle 110A may recognize the environmental object around the vehicle 110A based on the detection data of the sensor during the execution of step S10. The processor 126 may then modify the self-propelled direction DR (or the self-propelled route RT) in the vehicle movement operation MO or actuate the braking mechanism 118 to cause the vehicle 110A to make an emergency stop so as to avoid contact with the environmental object recognized from the detection data.

Upon completion of the vehicle movement operation MO in step S10, the processor 126 functions as the transmitting unit, and transmits a self-propulsion end signal G2 to the parking management server 16. When the processor 18 of the parking management server 16 receives the self-propulsion end signal G2 through the communication device 14, the processor 18 functions as the transmitting unit 30, and generates a self-propulsion command C3 for returning the vehicle 110A to the original parking position P0 and transmits the self-propulsion command C3 to the vehicle 110A from the communication device 14 (step S11).

As an example, when a predetermined time t1 elapses from a time t0 when the self-propulsion end signal G2 is received (or when the self-propulsion command C2 is transmitted in step S9), the processor 18 transmits the self-propulsion command C3 to the vehicle 110A. More specifically, the processor 18 transmits a command to a clock unit built in the parking management server 16 (not shown) at time t0, and starts clocking of an elapsed time t from the time t0. Then, when the elapsed time t reaches t=t1, the processor 18 transmits the self-propulsion command C3 to the vehicle 110A.

The predetermined time t1 may be stored in the memory 20 in advance. Alternatively, the user A may arbitrarily set a predetermined time t1. In this case, in step S1 described above, the user A may operate the mobile device 102 (for example, use the application a) to input the predetermined time t1, and attach information of the time t1 to the vehicle movement request RQ. In step S2 described above, the processor 18 of the parking management server 16 acquires the information of the predetermined time t1 together with the vehicle movement request RQ.

As another example, the processor 18 may determine the timing to transmit the self-propulsion command C3 to the vehicle 110A based on the imaging data IM_{110A} captured by the infrastructure sensor 12. Specifically, the processor 18 causes the infrastructure sensor 12 to continuously capture an image of the parking frame (or the parking location) serving as a location from which the vehicle 110A moves (moving source) at the time t0 or later, and determines whether the environmental object (for example, the user A) is present within the parking frame as the moving source based on the imaging data IM_{110A} acquired from the infrastructure sensor 12. Then, when the processor 18 determines that there is no environmental object in the parking frame as the moving source, the processor 18 transmits the self-propulsion command C3 to the vehicle 110A.

The processor 126 of the vehicle 110A causes the vehicle 110A to be self-propelled to the original parking position P0 as the vehicle movement operation MO in accordance with the self-propulsion command C3 received through the on-board communication device 120 (step S12). As an example, the processor 126 stores, in the memory 128, the self-propelled route RT (i.e., the self-propelled direction DR) along which the vehicle 110A is self-propelled from the parking position P0 to the parking position P1 in the vehicle movement operation MO in step S10 described above and the history data of the control amount (e.g., the rotational speed of the engine or the electric motor, the steering angle of the steering, and the timing of canceling and actuating the brake) by which the drive mechanism 114, the steering mechanism 116, and the braking mechanism 118 are actuated for self-propulsion.

Then, in step S12, the processor 126 automatically controls the drive mechanism 114, the steering mechanism 116, and the braking mechanism 118 such that the vehicle 110A is self-propelled along a route opposite to the self-propelled route RT in the vehicle movement operation MO in step S10. Thus, in step S12, the processor 126 can cause the vehicle 110A to be self-propelled to return to the original parking position P0 as the vehicle movement operation MO.

As another example, the self-propulsion command C3 transmitted from the parking management server 16 to the vehicle 110A may include control signals of the drive mechanism 114, the steering mechanism 116, and the braking mechanism 118. In this case, in step S12, the processor 126 of the vehicle 110A automatically controls the drive mechanism 114, the steering mechanism 116, and the braking mechanism 118 in accordance with the control signals included in the self-propulsion command C3, and causes the vehicle 110A to be self-propelled from the parking position P1 to the original parking position P0.

As described above, in the present embodiment, the processor 18 of the parking management server 16 functions as the receiving unit 26, the specifying unit 28, the transmitting unit 30, and the self-propelled route determination unit 42 and manages the vehicles 110 in the parking lot 100. Accordingly, the receiving unit 26, the specifying unit 28, the transmitting unit 30 and the self-propelled route determination unit 42 constitute a parking management device 50 for managing the vehicles 110 in the parking lot 100 (FIG. 5).

In the parking management device 50, the transmitting unit 30 transmits the self-propulsion command C2 to the vehicle 110A that has transitioned to the vehicle movement mode DM1 (step S9), and the vehicle 110A is self-propelled in the predetermined self-propelled direction DR as the vehicle movement operation MO in accordance with the self-propulsion command C2 received after the transition to the vehicle movement mode DM1 (step S10). According to this configuration, the user A can automatically move the vehicle 110A by transmitting the vehicle movement request RQ. Therefore, the vehicle 110A that interferes with the user A can be moved more easily, whereby the convenience of the user A can be further enhanced.

Further, in the parking management device 50, the receiving unit 26 further receives the imaging data IM_{110A} of the vehicle 110A from the infrastructure sensor 12 (step S7), and the self-propelled route determination unit 42 determines the self-propelled direction DR (or the self-propelled route RT) in which the vehicle 110A is self-propelled in the vehicle movement operation MO based on the imaging data IM_{110A} (step S8).

Then, the transmitting unit 30 generates the self-propulsion command C2 for causing the vehicle 110A to be self-propelled in the self-propelled direction DR determined by the self-propelled route determination unit 42 (step S9). According to this configuration, the self-propelled direction DR (the self-propelled route RT) in which the vehicle 110A does not contact with the environmental object can be automatically determined based on the imaging data IM_{110A}, whereby the vehicle 110A can be safely self-propelled in the vehicle movement operation MO in step S10.

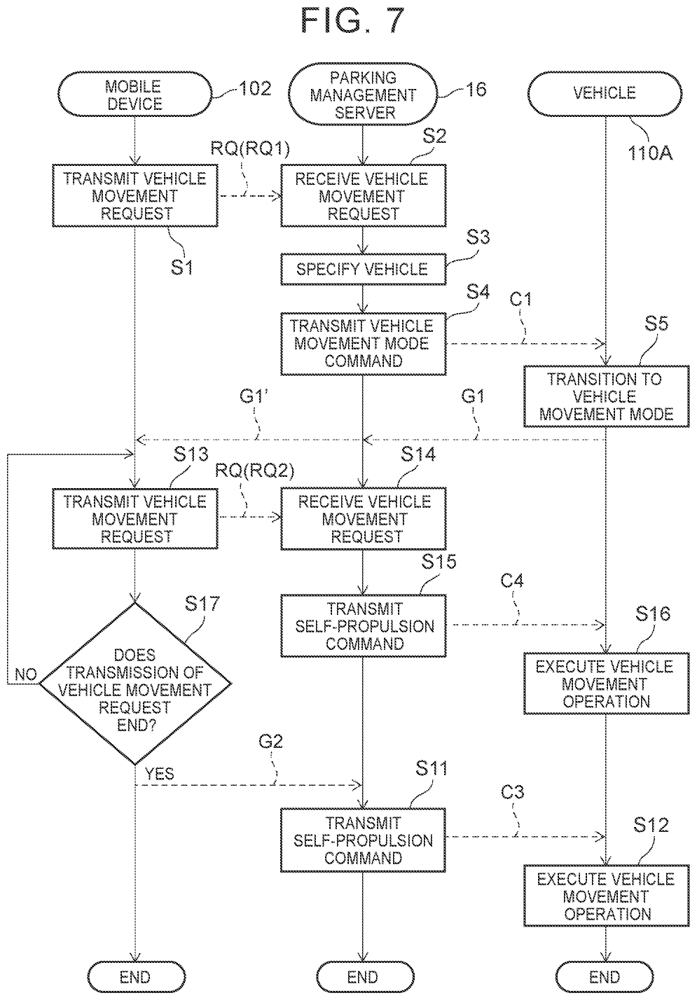

Next, with reference to FIGS. 2 and 7, a parking management method according to another embodiment will be described. The parking management system 10 shown in FIG. 2 further executes the flow of the parking management method shown in FIG. 7. The same or similar process as or to the flow shown in FIG. 6 in the flow shown in FIG. 7 is denoted by the same step number, and redundant description will be omitted.

In the flow shown in FIG. 7, when the mode transitions to the vehicle movement mode DM1 in step S5, the processor 126 of the vehicle 110A transmits the mode transition signal G1 to the parking management server 16. Upon receipt of the mode transition signal G1, the processor 18 of the parking management server 16 refers to the address AR_{A} of the mobile device 102, and transmits the mode transition signal G1′ to the mobile device 102 through the communication device 14.

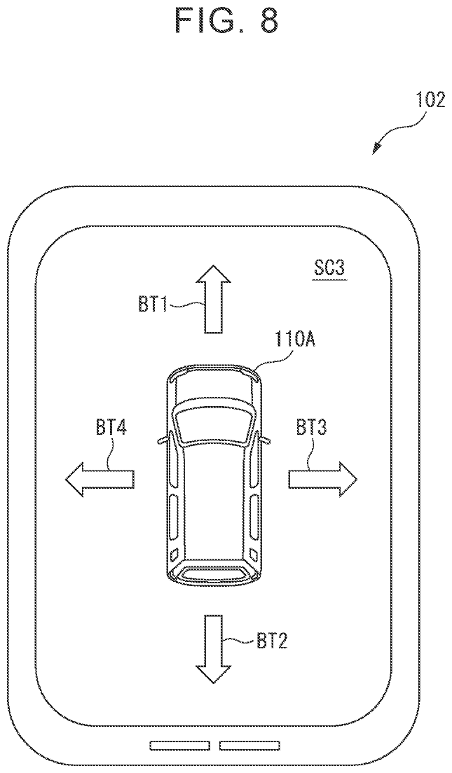

Upon receipt of the mode transition signal G1′, the mobile device 102 displays a vehicle operation screen SC3 of the application a on the display of the mobile device 102. The vehicle operation screen SC3 is a graphical user interface (GUI) for remotely controlling the vehicle 110A so as to be self-propelled. An example of the vehicle operation screen SC3 is shown in FIG. 8. As the vehicle operation screen SC3, any GUI other than the example shown in FIG. 8 may be applied.

In the example shown in FIG. 8, the vehicle operation screen SC3 includes an image of the vehicle 110A, arrow button images BT1, BT2, BT3 and BT4 for specifying the self-propelled direction DR for causing the vehicle 110A to be self-propelled. The arrow button images BT1, BT2, BT3 and BT4 are images for specifying the self-propelled direction DR of the vehicle 110A forward, backward, right and left, respectively.

When the user A performs the contact operation of the arrow button image BT1, BT2, BT3 or BT4 on the display while the user A visually checks the vehicle operation screen SC3 displayed on the display of the mobile device 102, the vehicle 110A can be self-propelled by remote operation while the self-propelled direction DR of the vehicle 110A is specified.

Hereinafter, a case where the user A performs a contact operation of the arrow button image BT1 on the mobile device 102 (i.e., performs the operation to specify the self-propelled direction DR forward) will be described. In response to the contact operation of the arrow button image BT1 by the user A, the mobile device 102 transmits the self-propulsion request RQ2 for causing the vehicle 110A to be self-propelled to the parking management server 16 as the vehicle movement request RQ (step S13). The self-propulsion request RQ2 transmitted at this time includes information specifying the self-propelled direction DR forward.

The processor 18 of the parking management server 16 functions as the receiving unit 26, and receives the vehicle movement request RQ (specifically, the self-propulsion request RQ2) from the mobile device 102 through the communication device 14 (step S14). Then, in response to the self-propulsion request RQ2 received, the processor 18 functions as the transmitting unit 30, and generates a self-propulsion command C4 for causing the vehicle 110A to be self-propelled in the self-propelled direction DR specified by the self-propulsion request RQ2 (in this example, forward).

The self-propulsion command C4 is a command for causing the vehicle 110A to be self-propelled in the self-propelled direction DR (forward) as the vehicle movement operation MO, and includes, for example, control signals for automatically controlling the drive mechanism 114, the steering mechanism 116, and the braking mechanism 118 of the vehicle 110A. The processor 18 functions as a transmitting unit 30, and transmits the generated self-propulsion command C4 to the vehicle 110A by operating the communication device 14 (step S15).

Then, in accordance with the self-propulsion command C4 received by the on-board communication device 120, after the processor 126 of the vehicle 110A automatically controls the drive mechanism 114, the steering mechanism 116, and the braking mechanism 118 and cancels actuation of the braking mechanism 118 as the vehicle movement operation MO, the vehicle 110A is self-propelled in the self-propelled direction DR (forward) specified by the user A (step S16). After that, when the vehicle 110A is self-propelled to the desired parking position P1, the user A ends the contact operation of the arrow button image BT1 displayed on the mobile device 102, thereby ending the transmission of the self-propulsion request RQ2.

The mobile device 102 determines whether the transmission of the vehicle movement request RQ (specifically, the self-propulsion request RQ2) is completed (step S17). For example, in step S17, the mobile device 102 determines YES when the contact operation of the arrow button image BT1 is not detected for a predetermined period of time. Meanwhile, the mobile device 102 determines NO while the contact operation is continued. Then, the process returns to step S13. The mobile device 102 may further display a self-propulsion end button image on the vehicle operation screen SC3 described above, and may determine YES in step S17 when the user A performs the contact operation of the self-propulsion end button image on the mobile device 102.

When the determination is YES in step S17, the mobile device 102 transmits the self-propulsion end signal G2 to the parking management server 16. Upon receipt of the self-propulsion end signal G2 through the communication device 14, the processor 18 of the parking management server 16 executes step S11 described above, and transmits the self-propulsion command C3 to the vehicle 110A. Then, the processor 126 of the vehicle 110A executes step S12 described above in accordance with the self-propulsion command C3, and causes the vehicle 110A to be self-propelled to the original parking position P0 as the vehicle movement operation MO.

As described above, in the present embodiment, the processor 18 of the parking management server 16 functions as the parking management device 40 (specifically, the receiving unit 26, the specifying unit 28, and the transmitting unit 30) and manages the vehicles 110 in the parking lot 100. In the parking management device 40 according to the present embodiment, the receiving unit 26 receives, as the vehicle movement request RQ, the self-propulsion request RQ2 for causing the vehicle 110A to be self-propelled, and in response to the self-propulsion request RQ2, the transmitting unit 30 generates the self-propulsion command C4 (step S15). According to this configuration, the user A remotely controls the vehicle 110A by operating the mobile device 102, and can automatically move the vehicle 110A.

Further, in the parking management device 40 according to the present embodiment, the self-propulsion request RQ2 includes information specifying the self-propelled direction DR, and the transmitting unit 30 generates the self-propulsion command C4 for causing the vehicle 110A to be self-propelled in the self-propelled direction DR specified in the self-propulsion request RQ2 (step S15). According to this configuration, the user A can move the vehicle 110A to the desired parking position P1 by arbitrarily specifying the self-propelled direction DR of the vehicle 110A.

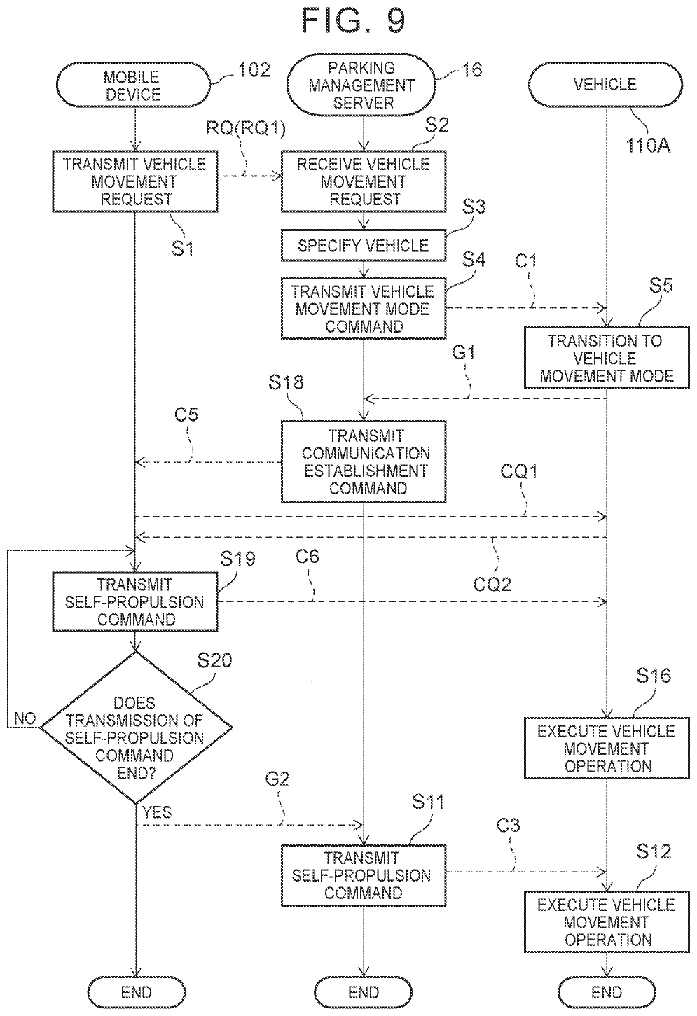

Next, with reference to FIGS. 2 and 9, a parking management method according to further another embodiment will be described. The parking management system shown in FIG. 2 further executes the flow of the parking management method shown in FIG. 9. The same or similar process as or to the flow shown in FIG. 7 in the flow shown in FIG. 9 is denoted by the same step number, and redundant description will be omitted.

In the flow shown in FIG. 9, upon receipt of the mode transition signal G1 transmitted from the vehicle 110A after step S5, the processor 18 of the parking management server 16 functions as the transmitting unit 30, and transmits a communication establishment command C5 to the mobile device 102 through the communication device 14 (step S18). The communication establishment command C5 is a command for establishing communication between the vehicle 110A that has transitioned to the vehicle movement mode DM1 and the mobile device 102, and, for example, includes information of the address AR_{110A} of the vehicle 110A and the like.

Upon receipt of the communication establishment command C5 from the parking management server 16, the mobile device 102 refers to the address AR_{110A} included in the communication establishment command C5, and transmits a communication establishment request CQ1 to the vehicle 110A that has transitioned to the vehicle movement mode DM1. On the other hand, the processor 126 of the vehicle 110A returns a communication establishment response CQ2 to the mobile device 102 in response to the communication establishment request CQ1 received through the on-board communication device 120. Thus, communication is established between the vehicle 110A and the mobile device 102. Note that, the vehicle 110A and the mobile device 102 may establish communication therebetween using any method other than communication with the communication establishment request CQ1 and the communication establishment response CQ2.

When communication with the vehicle 110A is established (that is, when the communication establishment response CQ2 is received from the vehicle 110A), the mobile device 102 displays, for example, the vehicle operation screen SC3 shown in FIG. 8 on the display of the mobile device 102. When the user A performs the contact operation of the arrow button image BT1, BT2, BT3 or BT4 on the display while the user A visually checks the vehicle operation screen SC3 displayed on the mobile device 102, the user A inputs a self-propulsion command C6 for causing the vehicle 110A to be self-propelled by the remote operation while the self-propelled direction DR of the vehicle 110A is specified.

Hereinafter, a case where the user A performs the contact operation of the arrow button image BT1 in the mobile device 102 (i.e., performs the operation to specify the self-propelled direction DR forward) will be described. In response to the contact operation of the arrow button image BT1 by the user A, the mobile device 102 transmits the self-propulsion command C6 for causing the vehicle 110A to be self-propelled to the vehicle 110A as the vehicle movement operation MO (step S19). The self-propulsion command C6 is a command for causing the vehicle 110A to be self-propelled in the self-propelled direction DR (in the present embodiment, forward), and includes, for example, control signals for automatically controlling the drive mechanism 114, the steering mechanism 116, and the braking mechanism 118 of the vehicle 110A.

In accordance with the self-propulsion command C6 received by the on-board communication device 120A, after the processor 126 of the vehicle 110A executes step S16 described above and cancels actuation of the braking mechanism 118 as the vehicle movement operation MO, the vehicle 110A is self-propelled in the self-propelled direction DR (forward) specified by the user A.

After that, when the vehicle 110A is self-propelled to the desired parking position P1, the user A ends the contact operation of the arrow button image BT1 displayed on the mobile device 102, thereby ending the transmission of the self-propulsion command C6. The mobile device 102 determines whether transmission of the self-propulsion command C6 ends (step S20).

For example, in step S20, the mobile device 102 determines YES when the contact operation of the arrow button image BT1 is not detected for a predetermined period of time. Meanwhile, the mobile device 102 determines NO while the contact operation is continued. Then, the process returns to step S19. The mobile device 102 may further display the self-propulsion end button image on the vehicle operation screen SC3 described above, and may determine YES in step S20 when the user A performs the contact operation of the self-propulsion end button image.

When the determination is YES in step S20, the mobile device 102 transmits the self-propulsion end signal G2 to the parking management server 16. Upon receipt of the self-propulsion end signal G2 through the communication device 14, the processor 18 of the parking management server 16 executes step S11 described above, and transmits the self-propulsion command C3 to the vehicle 110A. When the processor 126 of the vehicle 110A receives the self-propulsion command C3 through the on-board communication device 120, the processor 126 executes step S12 described above and causes the vehicle 110A to be self-propelled to the original parking position P0 as the vehicle movement operation MO.

As described above, in the present embodiment, the processor 18 of the parking management server 16 functions as the parking management device 40 (specifically, the receiving unit 26, the specifying unit 28, and the transmitting unit 30) and manages the vehicles 110 in the parking lot 100. In the parking management device 40 according to the present embodiment, the transmitting unit 30 transmits the communication establishment command C5 for establishing communication between the vehicle 110A that has transitioned to the vehicle movement mode DM1 and the mobile device 102 to the mobile device 102 (step S18).

Then, the vehicle 110A is self-propelled in the self-propelled direction DR as a vehicle movement operation MO in accordance with the self-propulsion command C6 transmitted from the mobile device 102 after communication with the mobile device 102 is established (step S16). According to this configuration, the user A remotely controls the vehicle 110A by directly transmitting the self-propulsion command C6 from the mobile device 102 to the vehicle 110A, whereby the user can move the vehicle 110A to the desired parking position P1.

Note that, in step S18 described above, the processor 18 of the parking management server 16 may transmit the communication establishment command C5 to the vehicle 110A. In this case, the communication establishment command C5 includes information and the like of the address AR_{A} of the mobile device 102. Then, upon receipt of the communication establishment command C5, the processor 126 of the vehicle 110A refers to the address AR_{A} included in the communication establishment command C5, and transmits the communication establishment request CQ1 to the mobile device 102 through the on-board communication device 120. On the other hand, the mobile device 102 returns the communication establishment response CQ2 to the vehicle 110A in response to the communication establishment request CQ1 received from the vehicle 110A. As described above, communication between the vehicle 110A and the mobile device 102 may be established.

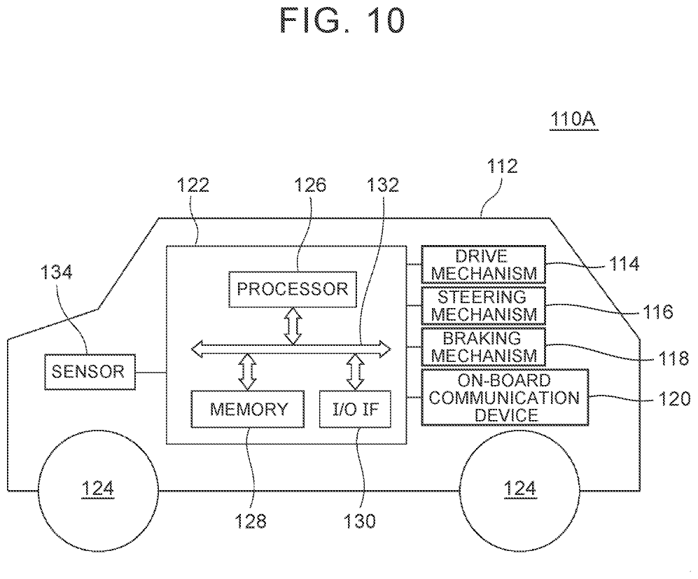

Next, with reference to FIGS. 2, 10, and 11, a parking management method according to further another embodiment will be described. In the present embodiment, the vehicle 110A further includes a sensor 134, as shown in FIG. 10. The sensor 134 detects a contact operation CO with respect to the vehicle 110A by the user A.

As an example, the sensor 134 includes a force sensor capable of sensing an external force f applied to the vehicle 110A. As described above, the sensor 134 may be configured to be interposed between the wheel 124 (or the axle) of the vehicle 110A and the braking mechanism 118 (or the vehicle body 112) and to detect torque f applied to the wheel 124 when the user A pushes the vehicle 110A by hand so as to move the vehicle 110A.

As another example, the sensor 134 includes a touch sensor capable of sensing contact c to the vehicle 110A by the user A. In this case, the sensor 134 is located at the front portion, the rear portion, or the side portion of the exterior 112A (e.g., body) of the vehicle 110A and detects contact c with the exterior 112A by the hand of the user A.

The sign indicating the installation position (seal, paint, etc.) may be provided on the exterior 112A such that the user A can visually recognize the installation position of the sensor 134 as a touch sensor. As described above, the sensor 134 detects the contact operation CO with respect to the vehicle 110A by detecting the external force f or the contact c, and supplies detection data δ indicating the detected contact operation CO to the processor 126.

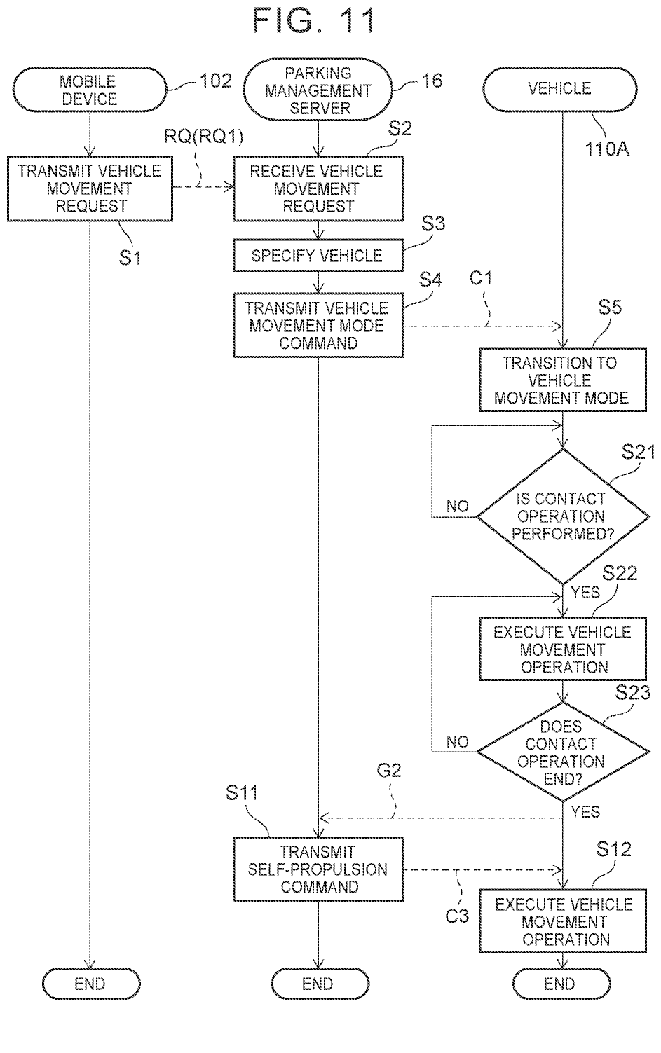

The parking management system 10 shown in FIG. 2 further executes the flow of the parking management method shown in FIG. 11. The same or similar process as or to the flow shown in FIG. 6 in the flow shown in FIG. 11 is denoted by the same step number, and redundant description will be omitted. In the flow shown in FIG. 11, when the mode transitions to the vehicle movement mode DM1 in step S5, the processor 126 of the vehicle 110A starts the operation of acquiring the detection data δ from the sensor 134 (e.g., periodically).

In the case where the sensor 134 includes a force sensor that detects the torque f, the processor 126 of the vehicle 110A may start an operation to acquire the detection data δ (i.e., torque f) after actuation of the braking mechanism 118 is canceled when the mode transitions to the vehicle movement mode DM1 in step S5. With the above, the sensor 134 can reliably detect the torque f applied to the wheel 124.

After starting the operation to acquire the detection data δ, the processor 126 of the vehicle 110A determines whether the contact operation CO with respect to the vehicle 110A by the user A is detected (step S21). Specifically, the processor 126 determines whether the contact operation CO is detected based on the detection data δ (e.g., the external force f or the contact c) acquired from the sensor 134. The processor 126 determines YES when the contact operation CO is detected and proceeds to step S22, while step S21 loops when the processor 126 determines NO.

When the determination is YES in step S21, the processor 126 automatically controls the drive mechanism 114, the steering mechanism 116, and the braking mechanism 118 in response to the contact operation CO detected in step S21 and cancels actuation of the braking mechanism 118 as the vehicle movement operation MO. Then, the processor 126 causes the vehicle 110A to be self-propelled in the predetermined self-propelled direction DR (step S22).

As an example, when the sensor 134 includes a force sensor, the processor 126 may detect the direction of the external force f applied by the user A as the contact operation CO to the vehicle 110A (e.g., the front or the rear of the vehicle 110A) based on the detection data δ of the external force f acquired from the sensor 134. Then, the processor 126 may determine the direction of the detected external force f as the self-propelled direction DR in which the vehicle 110A is self-propelled in step S22.

As another example, when the sensor 134 includes a touch sensor, the processor 126 may determine the self-propelled direction DR of the vehicle 110A based on the installation location of the sensor 134 that has detected the contact c. For example, the processor 126 may determine the self-propelled direction DR as the front of the vehicle 110A when the sensor 134 located on the rear portion of the exterior 112A detects the contact c. On the other hand, the processor 126 may determine the self-propelled direction DR as the rear of the vehicle 110A when the sensor 134 located on the front portion of the exterior 112A detects the contact c.

Thus, in step S22, in response to the contact operation CO detected by the sensor 134, the processor 126 causes the vehicle 110A to be self-propelled in the predetermined self-propelled direction DR as the vehicle movement operation MO. As a result, the user A can move the vehicle 110A to the desired parking position P1 by the contact operation CO.

Note that, when the contact operation CO in step S21 is detected, the processor 126 may cause the vehicle 110A to be self-propelled by a predetermined distance (e.g., a distance equal to the total length of the vehicle 110A), or may cause the vehicle 110A to be continuously self-propelled while the contact operation CO is detected.

Then, the processor 126 determines whether the contact operation CO by the user A ends (step S23). For example, the processor 126 may determine YES when the sensor 134 has not detected the contact operation CO for a predetermined period of time, while the processor 126 may determine NO when the sensor 134 is continuously detecting the contact operation CO. When the determination is YES in step S23, the processor 126 transmits the self-propulsion end signal G2 to the parking management server 16. On the other hand, when the determination is NO in step S23, the processor 126 returns to step S22 and continues the vehicle movement operation MO.

The processor 18 of the parking management server 16 executes step S11 described above in accordance with the self-propulsion end signal G2, and transmits the self-propulsion command C3 to the vehicle 110A. According to the self-propulsion command C3, the processor 126 of the vehicle 110A executes step S12 described above, and returns the vehicle 110A to the original parking position P0.

As described above, in the present embodiment, the vehicle 110A includes the sensor 134 that detects the contact operation CO by the user A, and is self-propelled in the predetermined self-propelled direction DR as the vehicle movement operation MO in accordance with the contact operation CO detected by the sensor 134 after the mode transitions to the vehicle movement mode DM1. According to this configuration, the user A can easily move the vehicle 110A to the desired parking position P1 by performing the contact operation CO with respect to the vehicle 110A.

Note that, the processor 18 of the parking management server 16 may execute the flow shown in FIG. 3, 6, 7, 9 or 11 in accordance with a computer program PG stored in the memory 20 in advance. Further, the function of the parking management device 40 or 50 (i.e., the receiving unit 26, the specifying unit 28, the transmitting unit 30, and the self-propelled route determination unit 42) executed by the processor 18 may be a functional module implemented by the computer program PG.

Further, as the parking management method, the flows shown in FIGS. 3, 6, 7, 9, and 11 are exemplified. However, various modification may be applied to the flow shown in FIG. 3, 6, 7, 9, or 11. For example, in step S6 in FIG. 3, the processor 18 of the vehicle 110A may cause the vehicle 110A to be self-propelled by a predetermined distance (e.g., a distance equal to the total length of the vehicle 110A) after actuation of the braking mechanism 118 is canceled as the vehicle movement operation MO.

Further, step S11 may be omitted from the flow shown in FIG. 6, 7, 9 or 11. For example, in the flow shown in FIG. 6 or 11, the processor 126 of the vehicle 110A may automatically start step S12 after step S10 is completed. Alternatively, in the flow shown in FIG. 7 or 9, when the determination is YES in step S17 or in step S19, the mobile device 102 may directly transmit the self-propulsion command C3 to the vehicle 110A.

As described above, the flow in FIG. 3, 6, 7, 9, or 11 may be appropriately modified. While the present disclosure has been described through the embodiments, the embodiments described above are not intended to limit the claimed disclosure. The present disclosure may be applied to autonomous driving (an autonomous driving vehicle).

What is claimed is:

1. A parking management device that manages a vehicle in a parking lot, comprising:
a receiving unit that receives a vehicle movement request transmitted from a user of the parking lot so as to move the parked vehicle;
a specifying unit that specifies the parked vehicle from among the vehicles in the parking lot based on the vehicle movement request; and
a transmitting unit that transmits a vehicle movement mode command to the parked vehicle, the vehicle movement mode command being a command for causing a driving mode of the parked vehicle specified by the specifying unit to transition to a vehicle movement mode in which the parked vehicle is caused to execute a vehicle movement operation for moving the parked vehicle.

2. The parking management device according to claim 1, wherein:
the receiving unit receives, as the vehicle movement request, a vehicle specification request including information that specifies the parked vehicle; and
the specifying unit specifies the parked vehicle based on the vehicle specification request.

3. The parking management device according to claim 2, wherein the information that specifies the parked vehicle includes an automobile registration number of the parked vehicle or an identification code uniquely assigned to the parked vehicle.

4. The parking management device according to claim 1, wherein:
the transmitting unit transmits a self-propulsion command to the parked vehicle that has transitioned to the vehicle movement mode; and
the parked vehicle is self-propelled, as the vehicle movement operation, in a direction that is predetermined in accordance with the self-propulsion command received after the parked vehicle has transitioned to the vehicle movement mode.

5. The parking management device according to claim 4, wherein:
the receiving unit further receives imaging data of the vehicle in the parking lot from an infrastructure sensor provided in the parking lot so as to capture an image of the vehicle;
the parking management device further includes a self-propelled route determination unit that determines the direction in which the parked vehicle is self-propelled in the vehicle movement operation based on the imaging data; and
the transmitting unit generates the self-propulsion command for causing the parked vehicle to be self-propelled in the direction determined by the self-propelled route determination unit.

6. The parking management device according to claim 4, wherein:
the receiving unit receives, as the vehicle movement request, a self-propulsion request for causing the parked vehicle to be self-propelled; and
the transmitting unit generates the self-propulsion command in accordance with the self-propulsion request.

7. The parking management device according to claim 6, wherein:
the self-propulsion request includes information that specifies the direction; and
the transmitting unit generates the self-propulsion command for causing the vehicle to be self-propelled in the direction specified in the self-propulsion request.

8. The parking management device according to claim 1, wherein:
the transmitting unit transmits a communication establishment command to the parked vehicle or a mobile device of the user, the communication establishment command being a command for establishing communication between the parked vehicle that has transitioned to the vehicle movement mode and the mobile device; and
after the communication between the parked vehicle and the mobile device is established, the parked vehicle is self-propelled, as the vehicle movement operation, in a predetermined direction in accordance with a self-propulsion command transmitted from the mobile device.

9. A vehicle that transitions to the vehicle movement mode in accordance with the vehicle movement mode command transmitted from the transmitting unit of the parking management device according to claim 1 and executes the vehicle movement operation.

10. The vehicle according to claim 9, wherein when the vehicle transitions to the vehicle movement mode, the vehicle cancels actuation of a braking mechanism as the vehicle movement operation.

11. The vehicle according to claim 9, wherein the vehicle
includes a sensor that detects a contact operation with respect to the vehicle by the user, and
is self-propelled, as the vehicle movement operation, in a predetermined direction in accordance with the contact operation detected by the sensor after the vehicle transitions to the vehicle movement mode.

12. A parking management method of managing a vehicle in a parking lot, wherein a processor
receives a vehicle movement request transmitted from a user of the parking lot so as to move the parked vehicle,
specifies the parked vehicle from among the vehicles in the parking lot based on the vehicle movement request, and
transmits a vehicle movement mode command to the parked vehicle, the vehicle movement mode command being a command for causing a driving mode of the parked vehicle specified to transition to a vehicle movement mode in which the parked vehicle is caused to execute a vehicle movement operation for moving the parked vehicle.
